(19) United States
(12) Patent Application Publication
(10) Pub. No.: US 2025/0349286 A1
(43) Pub. Date: Nov. 13, 2025

(54) SYSTEM AND METHOD FOR PARALLEL MULTILINGUAL VOICE COMMAND RECOGNITION

(71) Applicant: B/E Aerospace, Inc., Winston-Salem, NC (US)

(72) Inventors: Alexander Shilov, Weatogue, CT (US); Richa Varma, San Jose, CA (US)

(21) Appl. No.: 18/658,263

(22) Filed: May 8, 2024

(51) Int. Cl. G10L 15/18; G10L 15/02; G10L 15/06; G10L 15/22

(52) U.S. Cl. CPC G10L 15/1815; G10L 15/22; G10L 2015/025; G10L 15/063

(57) ABSTRACT

A system and method for parallel multi-lingual speech recognition captures spoken instructions from a user as an audio stream concurrently fed to a set of language models, each language model trained to a set of words, phonemes, and/or pronunciations in a particular language. Operating in parallel, each language model attempts to detect an intent of the spoken instructions by correlating the audio stream to a sequence of words and/or phonemes with sufficient confidence. When a language model detects a candidate intent, the candidate intent is stored to an intent buffer. An arbitrator reviews the intent buffers for each language model and attempts to select or infer from the set of candidates a final intent of the spoken instructions best matching the user's intent. For example, if a clear selection cannot be made, the final intent may be inferred based on, e.g., highest confidence level or highest frequency of selection).

### BACKGROUND

An increasing number of devices or systems are programmed for operation in response to voice commands and/or spoken directions. For example, personal mobile phones and smartphones, automotive components, internet-of-things (IoT) “smart” devices both inside and outside the home can be directed by speaking to them. In some cases, voice commands are a matter of convenience; in others, they are a matter of necessity, such as when a device cannot or should not be touched (e.g., due to distance, due to a hazardous environment).

Complicating the utility of voice-enabled devices and systems is the simple fact that language is not universal; voice commands may be given in a variety of languages and/or dialects, even within a relatively small geographical area, from users expecting the system to respond. Training these devices and systems for multi-language voice recognition or speech recognition involves various approaches. First, a device may be trained by each particular user for a specific set of commands. This approach may be language-agnostic because spoken directions are recognized without regard to the language in which they are spoken. However, in this case the device must be set up (which may be a lengthy and/or cumbersome process) for each individual user who wishes to interact with it.

Alternatively, voice/speech recognition models may be incorporated. For example, an automatic telephone-based assistance system may involve voice/speech recognition models each trained to receive and identify directions spoken in a particular language. While this approach may enable operation in multiple languages, such a system requires the user to initially select an operating language, whereby the appropriate language model may be loaded. However, some devices may not provide a means for the user to select a language (e.g., no user input device capable of accepting a selection).

Finally, voice recognition models may be trained on a limited set of commands that can be pronounced in different languages. While this approach may likewise be language-agnostic, it requires extensive training in order to recognize the set of commands as spoken by persons of varying age and gender or as spoken in different languages, and even in different dialects or variants within a language.

### SUMMARY

In a first aspect, a multilingual speech recognition system is disclosed. In embodiments, the speech recognition system includes a ring buffer for storing as an audio stream instructions spoken by a user (e.g., for operating or controlling a door, lighting, or other controlled system/s). The system includes a memory or other appropriate data storage for storing processor-executable instructions and one or more processors configurable by the encoded instructions. The system includes a set of language models connected in parallel to the ring buffer. Each language model is trained for a specific language on a set of words, phonemes, and/or pronunciations associated with that language (e.g., above and beyond the set of voice commands associated with the controlled system/s). Each language model operates in parallel to receive and analyze the audio stream, attempting to detect (e.g., with sufficient confidence) an intent of the spoken instructions (e.g., one or more specific voice commands associated with the controlled system/s, each intent associated with a selection frequency indicative of how often that intent is selected by the system) by associating the audio stream with a sequence of phonemes in its trained language. Each language model successfully detecting a candidate user intent records the candidate intent to an intent buffer. The system includes an arbitrator that attempts to select the actual and final user intent from the set of recorded candidate intents.

In some embodiments, the set of recorded candidate intents consists of a single candidate intent (e.g., one language model detects an intent, but no other language model detects an intent). Accordingly, the arbitrator selects the single candidate intent as the final user intent.

In some embodiments, when a single candidate intent is detected and selected by the arbitrator, the arbitrator increments the selection frequency of the selected single candidate intent.

In some embodiments, the memory stores a default language. For example, when a single candidate intent is detected and selected by the arbitrator as the final user intent, the arbitrator sets the default language to the language of the selected single candidate intent.

In some embodiments, when a subsequent audio stream is stored by the ring buffer (e.g., indicative of subsequent spoken instructions) and the detected and recorded candidate intents include a candidate intent of the same language as the default language (e.g., the language of the last selected single candidate intent), the arbitrator selects as the final user intent the recorded candidate intent matching the default language.

In some embodiments, each language model assigns a confidence level to each detected candidate intent and records the confidence level to the intent buffer along with the candidate intent.

In some embodiments (e.g., where multiple language models have detected and recorded a candidate intent for a given audio stream), the arbitrator infers as the final user intent the candidate intent having the highest confidence level.

In some embodiments, the arbitrator stores to memory the inferred final intent along with other information relevant to the inference, e.g., the associated sequence of phonemes, the confidence level of the inferred final intent.

In some embodiments, the set of recorded candidate intents includes two or more candidate intents sharing a highest confidence level (e.g., no single candidate intent having a highest confidence level) and the arbitrator infers as the final user intent the recorded candidate intent having the highest selection frequency.

In some embodiments, the arbitrator stores to memory a similarity metric associated with the two or more candidate intents sharing a highest confidence level. For example, the similarity metric may be based on, e.g., similarities (or dissimilarities) in associated voice command/s, similarities in phoneme sequence, and/or similarities in language between or among the recorded candidate intents.

In some embodiments, each recorded candidate intent corresponds to one or more voice commands executable by the controlled system/s, and the arbitrator forwards to the controlled system/s any voice commands corresponding to the selected final intent.

In some embodiments, the system further includes a microphone or other appropriate input device for capturing the spoken instructions as an audio stream.

In some embodiments, the arbitrator may fail to select or infer a final user intent from among the recorded candidate intents. For example, there may be no recorded candidate intents, i.e., no language model detects a candidate intent to a sufficient confidence level.

In some embodiments, when the arbitrator fails to select or infer a final user intent, the system may include an alert system to alert the user to the failure and/or prompt the user to repeat their spoken instructions (e.g., more clearly).

In a further aspect, a computer-assisted method for parallel multilingual speech recognition is also disclosed. In embodiments, the method includes receiving instructions spoken by a user (e.g., for controlling or operating one or more controlled systems) via an input device as an audio stream. The method includes storing the audio stream via a ring buffer. The method includes detecting, via a set of language models, one or more candidates for a final user intent of the audio stream (e.g., the actual instructions spoken by the user). For example, each language model is trained for a specific language and according to a set of words, phonemes, pronunciations, etc. for that language and attempts to detect a candidate intent (e.g., to a sufficient confidence level) by associating the audio stream with a sequence of phonemes in its trained language, which sequence may map to one or more specific voice commands associated with the controlled system/s. Each candidate intent may be associated with a selection frequency indicative of how often that candidate intent is selected as a final user intent. The method includes, for each language model successfully detecting a candidate user intent, recording the candidate intent to an intent buffer. The method includes attempting to select or infer a final user intent of the audio stream via an arbitrator connected to the set of intent buffers.

In some embodiments, the arbitrator is connected to a memory capable of storing a default language. For example, when the set of candidate user intents recorded to the intent buffers includes a single candidate intent, the method includes selecting, via the arbitrator, the single candidate intent as the final user intent. The method further includes setting the language associated with the selected final user intent (e.g., the language of the language model that detected the single candidate intent) as the default language.

In some embodiments, the method includes incrementing, via the arbitrator, the selection frequency of the single candidate intent selected as the final user intent.

In some embodiments, a subsequent audio stream may be analyzed by the language models, who each attempt to detect candidate intents. When the set of recorded candidate intents includes a candidate intent matching the current default language (e.g., detected by the same language model that detected the most recent single candidate intent selected as a final intent), the method includes selecting as the final user intent the recorded candidate intent matching the default language.

In some embodiments, the method includes determining, via each language model, a confidence level associated with a detected candidate intent and recording the confidence level to the intent buffer along with the detected candidate intent. The method includes, when multiple candidate intents are detected and recorded, selecting (via the arbitrator) as the final user intent the recorded candidate intent having the highest confidence level.

In some embodiments, where two or more recorded candidate intents may share a highest confidence level or there is otherwise no recorded candidate intent having a highest confidence level (e.g., confidence levels are not available), the method includes inferring as the final user intent the recorded candidate intent having the highest selection frequency.

This Summary is provided solely as an introduction to subject matter that is fully described in the Detailed Description and Drawings. The Summary should not be considered to describe essential features nor be used to determine the scope of the Claims. Moreover, it is to be understood that both the foregoing Summary and the following Detailed Description are example and explanatory only and are not necessarily restrictive of the subject matter claimed.

### BRIEF DESCRIPTION OF THE DRAWINGS

The detailed description is described with reference to the accompanying figures. The use of the same reference numbers in different instances in the description and the figures may indicate similar or identical items. Various embodiments or examples (“examples”) of the present disclosure are disclosed in the following detailed description and the accompanying drawings. The drawings are not necessarily to scale. In general, operations of disclosed processes may be performed in an arbitrary order, unless otherwise provided in the claims. In the drawings:

FIG. 1 is a block diagram illustrating a multilingual speech recognition system according to example embodiments of this disclosure;

FIG. 2 is a diagrammatic illustration of an operational flow of arbitration operations of the multilingual speech recognition system of FIG. 1; and

FIG. 3 is a flow diagram illustrating a computer-assisted method for multilingual recognition of voice commands according to example embodiments of this disclosure.

### DETAILED DESCRIPTION

Before explaining one or more embodiments of the disclosure in detail, it is to be understood that the embodiments are not limited in their application to the details of construction and the arrangement of the components or steps or methodologies set forth in the following description or illustrated in the drawings. In the following detailed description of embodiments, numerous specific details may be set forth in order to provide a more thorough understanding of the disclosure. However, it will be apparent to one of ordinary skill in the art having the benefit of the instant disclosure that the embodiments disclosed herein may be practiced without some of these specific details. In other instances, well-known features may not be described in detail to avoid unnecessarily complicating the instant disclosure.

As used herein a letter following a reference numeral is intended to reference an embodiment of the feature or element that may be similar, but not necessarily identical, to a previously described element or feature bearing the same reference numeral (e.g., 1, 1a, 1b). Such shorthand notations are used for purposes of convenience only and should not be construed to limit the disclosure in any way unless expressly stated to the contrary.

Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of “a” or “an” may be employed to describe elements and components of embodiments disclosed herein. This is done merely for convenience and “a” and “an” are intended to include “one” or “at least one,” and the singular also includes the plural unless it is obvious that it is meant otherwise.

Finally, as used herein any reference to “one embodiment” or “some embodiments” means that a particular element, feature, structure, or characteristic described in connection with the embodiment is included in at least one embodiment disclosed herein. The appearances of the phrase “in some embodiments” in various places in the specification are not necessarily all referring to the same embodiment, and embodiments may include one or more of the features expressly described or inherently present herein, or any combination or sub-combination of two or more such features, along with any other features which may not necessarily be expressly described or inherently present in the instant disclosure.

Broadly speaking, embodiments of the inventive concepts disclosed herein are directed to a system and method for multi-lingual speech recognition that enables a variety of systems and devices to respond to voice commands and/or spoken directions in multiple languages. For example, an aircraft lavatory may be responsive to voice commands, e.g., open door, close door, lights on, lights off, in a variety of languages (e.g., English, German, French, Spanish) but may not include a means for allowing a user who may speak one or more of these languages to select an operating language with which they may communicate with the system. Embodiments of the system or method solve this problem via language models widely available and pre-trained across a broad library of words and pronunciations thereof, and working in parallel to identify candidate commands that, according to their analysis, correspond to what the user is saying. Based on the results of this parallel analysis, which may include one or more candidate commands, the system selects the candidate most likely indicative of the user's intent.

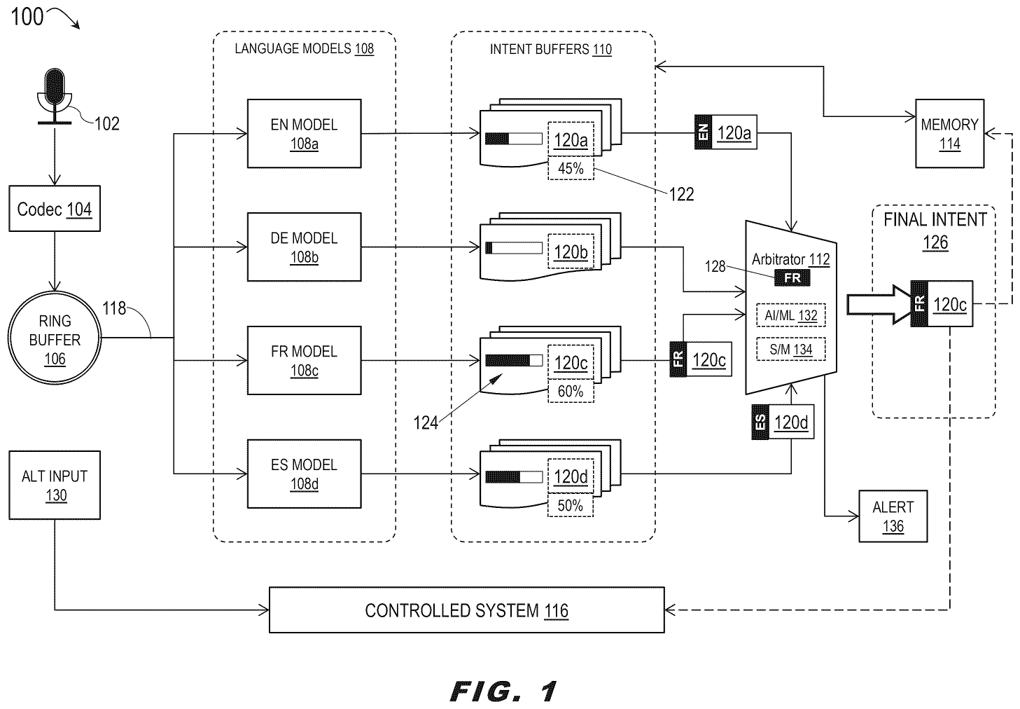

Referring to FIG. 1, a multilingual speech recognition system 100 is disclosed. The system 100 may include an input device 102, coder/decoder 104 (codec), ring buffer 106, two or more language models 108, intent buffers 110, arbitrator 112, and memory 114.

In embodiments, the codec 104, language models 108, or arbitrator 112 may be configured for execution on one or more processors (e.g., configurable via encoded instructions stored to memory 114). For example, the speech recognition system 100 may be a component of a larger controlled system 116 via which one or more specific tasks are performed in response to commands spoken by a user. In embodiments, the controlled system 116 may include, but is not limited to: an aircraft-based lavatory within a passenger cabin, commanded to open or close a door, activate or deactivate lights within the lavatory; a coffee machine or similar beverage maker commanded to dispense hot water or brew a particular beverage; a telephone-based assistance system able to speak with callers, and provide assistance to them, in their native language or in a language in which they are able to communicate.

In embodiments, the input device 102 may include a microphone or similar device for receiving spoken directions from a user. Alternatively, the speech recognition system 100 may receive an audio stream 118 or audio file corresponding to spoken directions from an input device outside the system. For example, spoken directions may be received via the input device 102 and digitized (e.g., converted into a digital format, compressed, filtered, or otherwise encoded) by the codecs 104 into a standardized digital audio stream.

In embodiments, the audio stream 118 produced by the codec/s 104 may be stored to the ring buffer 106 for real time or near real time analysis by the language models 108. For example, an implementation of the speech recognition system 100 may include two, three, or any practical number of language models 108 configured for concurrent parallel operation, each language model trained according to a specific language (e.g., English (EN) language model 108a; German (DE) language model 108b; French (FR) language model 108c; Spanish(ES) language model 108d) and pre-trained with phonemes and a comprehensive library of words within a confined domain (context) of the application (including different pronunciations of a particular word) that extends above and beyond any commands or terminology specific to the controlled system 116. In embodiments, the set of language models 108 incorporated by the speech recognition system 100 may include any number of languages, whether these languages are linguistically similar (e.g., English, Dutch, German; French, Spanish, Italian) or more distinct from each other (e.g., Russian, Japanese, Hindi), as regional considerations demand. Further, language models 108 may be specific to dialects or variants (whether mutually intelligible or not) within a language (e.g., Mandarin/Cantonese variants of Chinese; US/UK/RSA variants of English; European/American variants of Spanish or Portuguese).

In embodiments, each language model 108, 108a-108d may simultaneously receive the audio stream 118 from the codecs 104 or from the ring buffer 106, and may analyze the audio stream in parallel to detect an intent of the corresponding voice command or spoken direction. For example, each language model 108, 108a-108d may analyze the audio stream 118 by attempting to correlate the audio stream, i.e., a sequence of sounds, to a sequence of phonemes associated with the trained language of that language model. A phoneme is a unit of speech sound (e.g., a “phone”) perceptually distinct from other phonemes and capable of distinguishing different words within a language (e.g., via substitution of one phoneme for another phoneme, as in English “bit” and “big”. For example, spoken English is generally understood to incorporate some 40 to 50 distinct phonemes (the precise amount may vary among dialects and/or regional variants) including, e.g., consonants, vowels (long, short, consonant-controlled), and consonant digraphs (phonemes incorporating two or more consonants in combination).

In embodiments, each language model 108 may analyze the audio stream 118 by attempting to correlate the audio stream to a sequence of phonemes and attempt to detect the user's intent by matching the correlated sequence of phonemes to a reference word, phrase, or sentence corresponding to one of the known predefined classes. For example, each language model 108 may likewise store a learned vocabulary or library of words (and/or different pronunciations of words) as phoneme sequences. In embodiments, the language model 108a, 108c, 108d operating in parallel may successfully detect an intent 120a, 120c, 120d of the user by correlating the audio stream 118 to a sequence of phonemes (and therefore a sequence of words) known to that language model to a sufficient confidence level 122. In some embodiments, the language model 108 may determine a specific confidence level 122 (e.g., reliability, likelihood of correctness) indicative of the similarity between the audio stream 118 (and the correlated sequence of phonemes) and/or the likelihood that the correlated sequence of phonemes (and/or words and phrases) matches an intent (e.g., a word, phrase, sentence, command) known to that language model.

In embodiments, intents 120a, 120c, 120d may include specific commands or command sequences executable by the controlled system 116, which commands or command sequences may be associated with specific words or phrases, e.g., “open door”, “close door”, “shut door”, “lights on”, “lights up”, “lights off”. For example, each intent 120a, 120c, 120d associated with a particular language model 108a-108d may also be associated with a specific selection frequency 124 (e.g., probability) indicative of the number of times that intent has been selected by the arbitrator 112 as a final intent 126 (in other words, the number of times the user has utilized the speech recognition system 100 to execute that intent).

In embodiments, the arbitrator 112 may store for each language model 108a-108d the selection frequencies 124 corresponding to their respective intents 120a, 120c, 120d to memory 114. For example, storing selection frequencies 124 long-term to memory 114 may enable the arbitrator 112 to infer (e.g., if a clear selection cannot be made) user intent from confidence levels 122 or from selection frequencies, e.g., if confidence levels 122 are unavailable or unhelpful. In embodiments, when a particular candidate intent 120c is selected by the arbitrator 112 as a final intent 126 of the user by virtue of being the sole recoded candidate intent 120, the arbitrator may increment the selection frequency 124 of the selected final intent. However, if a selection is made on the basis of a match for the default language 128, or a clear selection cannot be made, as described in greater detail below, the arbitrator 112 may select the matching candidate intent 120c or infer a particular candidate intent 120a, 120c, 120d as a final intent 126, but decline to increment the selection frequency 124 or set the default language 128 as a result.

In some embodiments, the arbitrator 112 may recognize (and, e.g., store to memory 114) a default language 128. For example, when the arbitrator 112 selects the French-language candidate intent 120c detected by the FR language model 108c as the final intent 126 because it is the single candidate intent detected and recorded, the arbitrator may set the default language 128 to French (FR). For example, a subsequent audio stream 118 may be received by the speech recognition system 100 and the FR language model 108c may subsequently detect and record a FR candidate intent 120c based on the subsequent audio stream. In embodiments, if the arbitrator 112 has set the default language 128 to French (FR), e.g., the most recently selected (rather than inferred) final intent 126 was a French-language candidate intent 120c, the arbitrator may select as the final intent 126 of the subsequent audio stream the candidate intent 120c provided by the FR language model 108c (e.g., if a French-language candidate intent is provided).

In embodiments, any language model 108a, 108c, 108d successfully detecting a candidate intent 120a, 120c, 120d may record the detected candidate intent (and the corresponding confidence level 122, if a specific confidence level is determined or known) in an intent buffer 110. For example, each language model 108a-108d may have its own intent buffer 110, but not all language models 108a-108d may provide a candidate intent 120a, 120c, 120d based on each received audio stream 118. For example, as shown by FIG. 1, the EN, FR, and ES language models 108a, 108c, 108d may each detect and record a candidate intent 120a, 120c, 120d of the current audio stream 118 in their respective intent buffers 110. However, the DE language model 108b may not be able to match the audio stream 118 to a sequence of phonemes or words to a sufficient confidence level 122, and thus the intent buffer 110 of the DE language model may remain without a recorded candidate intent 120b.

In embodiments, if a clear selection of a final intent (e.g., on the basis of single candidate intent or matching the default language 128) the arbitrator 112 may attempt to select or infer a final intent 126 of the audio stream 118 based on the recorded candidate intents 120a, 120c, 120d detected by each of the language models 108, 108a-108d. For example, for a given audio stream 118 the language models 108a-108d may detect more than one possible candidate intent 120a, 120c, 120d of the audio stream (e.g., each language model 108a, 108c, 108d may detect a most likely candidate intent 120a, 120c, 120d, with the exception of the DE language model 108b), and one or more of these detected candidate intents may differ (e.g., the candidate intent 120a detected by the EN language model 108a (e.g., “open door”) may correspond to a different voice command than the candidate intent 120c detected by the FR language model 108c (e.g., “lights on”)). In embodiments, if only one language model 108c has detected a candidate intent 120c of the audio stream 118, the arbitrator 112 may select the detected candidate intent as the final intent 126. Similarly, if the default language 128 is currently set to French, the arbitrator 112 may likewise select the French-language candidate intent 120c as the final intent 126.

In embodiments, if no selection of a final intent 126 can be made either on the basis of a single candidate intent or a match to the default language 128, the arbitrator 112 may instead infer a final intent. For example, if each of the detected candidate intents 120a, 120c, 120d recorded in the intent buffers include a confidence level 122, the arbitrator 112 may infer as the final intent 126 the detected candidate intent 120c (e.g., detected by the FR language model 108a) having the highest confidence level (e.g., 60%, as opposed to 50% for the ES intent 120d and 45% for the EN intent 120a).

In some embodiments, confidence levels 122 may be unavailable or unhelpful to the arbitrator 112. For example, the arbitrator 112 may be presented with two or more detected candidate intents 120a, 120c, 120d all sharing a highest confidence level 122. The speech recognition system 100 may be newly implemented and may not have a large database of selection frequency 124 and/or confidence level 122, and thus for a given audio stream, multiple language models 108a, 108c, 108d may detect candidate intents 120a, 120c, 120d having equivalent confidence levels. Alternatively, the languages associated with the various language models 108a-108d may be very similar (e.g., English, Dutch, German; French, Spanish, Italian), and thus the detected candidate intents 120a, 120c, 120d may also be very similar (e.g., same voice commands, similar sounds or phonemes) but based in different languages, which may frustrate the ability of the arbitrator 112 to choose the correct language. For example, the user may provide spoken instructions in Italian, which the arbitrator 112 may correctly interpret (e.g., as instructions to open a door) but in the wrong language (e.g., by selecting as a final intent 126 the Spanish-language candidate intent 120d provided by the ES language model 108d).

In some embodiments, then, when presented with multiple candidate intents 120a, 120c, 120d sharing a highest confidence level 122, the arbitrator 112 may infer as the final intent 126 the candidate intent having the highest selection frequency 124. For example, when the arbitrator 112 infers a final intent 126 by selecting from a pool of multiple candidate intents 120a, 120c, 120d sharing a highest confidence level 122 the candidate intent (e.g., French-language candidate intent 120c provided by the FR language model 108c) having the highest selection frequency 124, the arbitrator may also decline to increment the selection frequency of the French-language candidate intent 120, or to set the default language 128, to reflect this selection. In this way, the arbitrator 112 may prevent inferences from affecting future selections while allowing clearer selections of final intents 126 to provide useful feedback.

In embodiments, the selection frequency 124 of a candidate intent 120a-120d may reflect not only the frequency with which that candidate intent has been selected (e.g., but not inferred) by the arbitrator 112 as a final intent 126, but the frequency with which that candidate intent has been correctly selected as a final intent (e.g., accurately reflecting the true intent of the user providing the audio stream 118) and thus a probability that a given candidate intent may subsequently be correctly selected as a final intent. For example, the arbitrator 112 may be pre-trained (e.g., using machine learning (ML) based on historical data) with initial or predetermined selection frequencies 124 (e.g., and/or possible commands and/or sequences thereof) attached to one or more candidate intents 120a-120d stored to memory 114 by the various language models 108a-108d. Accordingly, the arbitrator 112 may be initially inclined to infer as a final intent 126 candidate intents 120a-120d having a higher predetermined selection frequency 124, continuing to adjust the various selection frequencies of the various candidate intents as some candidate intents are selected as final intents and other candidate intents are inferred or passed over entirely.

In other embodiments, the arbitrator 112 may “learn as it goes” by recording (e.g., storing to memory 114 any selected final intents 126 in addition to any associated confidence levels 122, selection frequencies 124, sequences of phonemes correlated with the audio stream, languages (e.g., the language model 108a-108d detecting the selected candidate intent 120a-120d), and/or information as to the correctness and/or accuracy of the arbitrator's selection. For example, if a candidate intent 120a-120d selected by the arbitrator as a final intent 126 is subsequently determined to be a correct or accurate selection by some feedback mechanism, e.g., correctly capturing the intent of the user, the correctness of the selected final intent may likewise be stored to memory. Further, the arbitrator 112 may increment the selection frequency 124 of a selected final intent 126 to reflect a correct selection and/or decrement the selection frequency of a selected final intent to reflect an incorrect or inaccurate selection. In some embodiments, the arbitrator 112 may also employ a hybrid technique combining one or more of the above-mentioned approaches.

In some embodiments, when the speech recognition system 100 allows alternative means 130 for input of voice commands to the controlled system 116, e.g., touching a button to issue the corresponding action/command, the arbitrator 112 may be equipped with one or more artificial intelligence (Al) and/or ML models 132 for matching selected final intents 126 to control input provided via alternative input means 130. For example, by comparing selected final intents 126 to control input provided via alternative input means 130, the arbitrator 112 may “learn as it goes” by using feedback provided by the alternative control input to improve the accuracy of subsequent selections (e.g., by assessing the accuracy of past selections). In some embodiments, the AI and/or ML models 132 may additionally learn possible command sequences, e.g., turning on a drier after a user washes their hands.

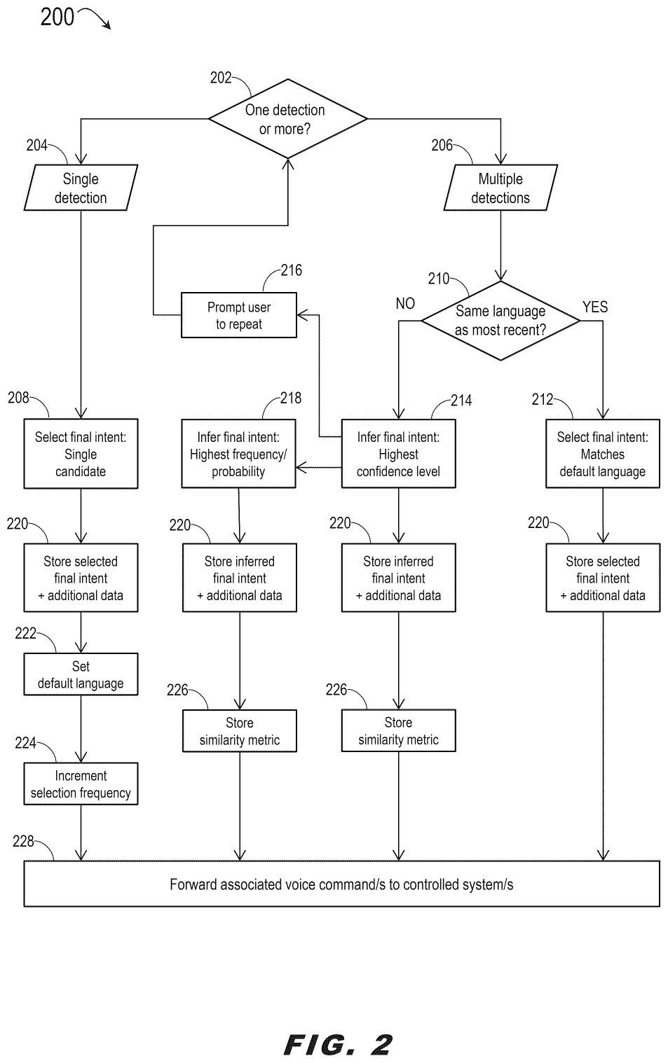

In embodiments, the speech recognition system 100 may record (e.g., to memory 114) which candidate intents 120a-120d are selected as a final intent 126 (which may include the associated audio streams 118, correlated phoneme sequences, associated languages, associated confidence levels 122, and/or other candidate intents 120a, 120d not selected as final intent), as shown by FIG. 2 below. In other embodiments, if two or more candidate intents 120a, 120c detected by the language models 108a, 108c correspond to the same voice command while a third candidate intent 120d does not, the arbitrator 112 may infer as a final intent 126 the voice command corresponding to the two or more similar candidate intents. In some embodiments, when the arbitrator 112 infers a final intent 126 by selecting from a pool of multiple candidate intents 120a, 120c, 120d sharing a highest confidence level 122 (e.g., or the candidate intent having the highest selection frequency 124), the arbitrator 112 may further record (e.g., to memory 114) similarity metrics 134 from which the arbitrator and/or ML models 132 may infer subsequent selections. For example, when the arbitrator 112 infers a final intent 126 by selecting from a pool of multiple candidate intents 120a, 120c, 120d sharing a highest confidence level 122, the similarity metrics 134 may record any similarities, dissimilarities, or degrees of similarity among, e.g., the correlated phoneme sequences, languages, and/or commands/instructions associated with each candidate intent.

In some embodiments, the arbitrator 112 may fail to select or infer a final intent 126. For example, none of the candidate intents 120a-120d may be associated with a sufficiently high confidence level 122 or accurate selection frequencies 124. For example, the speech recognition system 100 may further incorporate an alert system 136. In embodiments, when the arbitrator 112 fails to select or infer a final intent 126, the alert system 136 may prompt the user (e.g., via auditory alert, spoken request, simple visual alert such as a red or blinking light) to repeat the spoken instructions.

In other embodiments, when the arbitrator 112 is presented with multiple candidate intents 120a, 120c, 120d all sharing a highest confidence level 122 (as discussed above, whereby the arbitrator may infer a final intent 126), the arbitrator may first prompt the user to repeat the spoken instructions, providing a new audio stream 118 for the language models 108a-108d to analyze. If, for example, the new or subsequent audio stream 118 provides similar results to the previous audio stream (e.g., multiple candidate intents 120a, 120c, 120d all sharing a highest confidence level 122), the arbitrator 112 may then infer a final intent 126 based on selection frequency 124. In embodiments, the arbitrator 112 may forward the selected or inferred final intent 126 of the audio stream 118 to the controlled system 116 for further action. For example, the controlled system 116 may execute the command or commands associated with the final intent 126. In embodiments, the arbitrator 112 may store to memory 114 one or more of the selected or inferred final intent 126, the associated language, the confidence level 122 (e.g., if a confidence level exists), the sequence of phonemes correlated with the audio stream 118, any assorted commands associated with the selected final intent, and/or information about the accuracy of the selection (e.g., was a prompt necessary, was an inference made rather than a selection, were one or more prior selection attempts unsuccessful, correlating command information from alternative input means 130 confirming or contradicting the selection).

Referring now to FIG. 2, the operational flow 200 of the arbitrator (112, FIG. 1) is shown. For example, referring back to FIG. 1, the operational flow 200 may assume that an audio stream 118 is received by an input device 102 and processed by the codecs 104, that the language models 108a-108d have analyzed the audio stream in parallel, and that at least one language model has detected a candidate intent 120a, 120c, 120d of the audio stream (e.g., by correlating the audio stream with a sequence of phonemes associated with trained language of the language model) and recorded said candidate intent to its respective intent buffer 110.

At step 202, the arbitrator 112 determines whether the intent buffers 110 reflect one detection (step 204) or multiple detections (step 206). At a step 204, for example, a single candidate intent 120 may be detected and recorded, and at a step 208 the arbitrator 112 selects the single candidate intent as a final intent 126.

At a step 206, where multiple language models 108a-108d have detected and recorded a candidate intent 120a-120d, the arbitrator refers to the default language 128 corresponding to the language model 108a-108d that detected the candidate intent most recently selected as a final intent 126 (e.g., provided that the selection was a single detected candidate intent (step 208) or based on a high confidence level 122, rather than an inferred final intent based on selection frequency 124 (e.g., probability)). If a default language 128 is currently set, at a step 210, the arbitrator determines whether any candidate intent 120a-120d matches the default language. If, at a step 212, a candidate intent 120a-120d matches the current default language 128, the arbitrator 112 selects that candidate intent as the final intent 126.

At a step 214, if multiple candidate intents 120a-120d are recorded but no default language 128 is currently set (or if no recorded candidate intent matches the default language), the arbitrator 112 instead refers to the confidence levels 122 associated with each detected candidate intent and recorded (along with the corresponding candidate intent) to the intent buffers 110. Accordingly, the arbitrator 112 infers as the final intent 126 the candidate intent 120a-120d having the highest confidence level 122, if such a candidate intent exists.

In some embodiments, the arbitrator 112 may fail to infer a final intent 126 from multiple candidate intents 120a-120d based on confidence levels 122. For example, several candidate intents 120a-120d may share a highest confidence level 122, and may even correspond to the same command/s, but there being no single highest confidence level the arbitrator 112 may not be able to infer a final intent on this basis. Alternatively, no language model 108a-108d may detect a candidate intent 120a-120d with sufficient confidence. At a step 216, the arbitrator may alert the user or prompt the user to repeat their spoken instructions so that a new audio stream 118 may be generated and evaluated by the language models 108a-108d and detection of candidate intents 120a-120d may be achieved with more precise confidence levels 122.

Alternatively, the arbitrator 112 may refer to the selection frequency 124 associated with each candidate intent 120a-120d and based, e.g., on the frequency with which a particular candidate intent has been historically selected as a final intent 126. The selection frequency 124 may further be at least partially based on how frequently the candidate intent 120a-120b has been correctly selected as a final intent 126. For example. at a step 218 the arbitrator 112 may infer a final intent 126 by selecting as the final intent the candidate intent having the highest selection frequency 124. In some embodiments, the arbitrator 112 may engage AL/ML models 132 to infer the likelihood that a selected final intent 126 correctly interprets an intended command or sequence thereof based on, e.g., historical data on selected and executed command sequences or other characteristics.

At a step 220, once a final intent 126 has been selected or inferred, the arbitrator 112 may store (e.g., to memory 114) the selected or inferred final intent as well as any other relevant information that may assist the arbitrator in learning to more accurately select or infer final intents based on subsequent audio streams 118. For example, the arbitrator may store one or more of: the confidence level 122 of the selected or inferred final intent 126 (if available), the sequence of phonemes correlated by the language model 108a-108d based on the audio stream 118 to detect the selected or inferred final intent; as well as any unselected candidate intents 120a-120d (and confidence levels and/or phoneme sequences associated with said candidate intents).

At a step 222, if no default language 128 was currently set and the arbitrator 112 selected a final intent 126 based on a single candidate intent (step 208), the arbitrator sets as the default language (and stores said default language to memory 114) the language associated with the single candidate intent 120 most recently selected as a final intent. (If, for example, the arbitrator 112 selected the final intent 126 based on a current default language (step 212), the default language will remain and does not need to be set.) At a step 224, when the arbitrator 112 selects a final intent 126 as a single candidate (step 208) the arbitrator 112 increments the selection frequency 124 associated with the selected final intent. In some embodiments, when the selection of a final intent 126 by the arbitrator 112 is subsequently determined to have been either a correct or an incorrect selection (e.g., via alternate control input confirming or contradicting the correctness of the selected final intent), the arbitrator may also respectively increment or decrement the selection frequency of the selected final intent.

When the arbitrator 112 either selects a final intent 126 on the basis of a match for the default language 128 (step 212) or infers a final intent 126 based on the highest confidence level 122 and/or selection frequency 124 and/or probability among candidate intents 120a-120d (steps 214, 218), the arbitrator may neither set the default language (step 222) nor increment the selection frequency (step 224) based on the final intent.

However, at a step 226, the arbitrator 112 may determine and store (e.g., to memory 114) a similarity metric 134 based on any similarities, dissimilarities, and/or degrees of similarity between or among the candidate intents 120a-120d from which the final intent 126 was inferred, e.g., similarities in languages, similarities in associated voice command/s, similarities in correlated phoneme sequences.

At a step 228, the arbitrator 112 may forward the selected or inferred final intent 126, and/or the associated voice command/s, to the controlled system/s 116 for further action. For example, at a step 224 the controlled system 116 may execute the command or commands associated with the selected or inferred final intent 126.

In some embodiments, the arbitrator 112 may be trained according to end-to-end learning methods, e.g., as may be associated with multi-device arbitration scenarios, to better select or infer final intents 126 and/or improve arbitration methods based on accumulated knowledge of past selections and inferences.

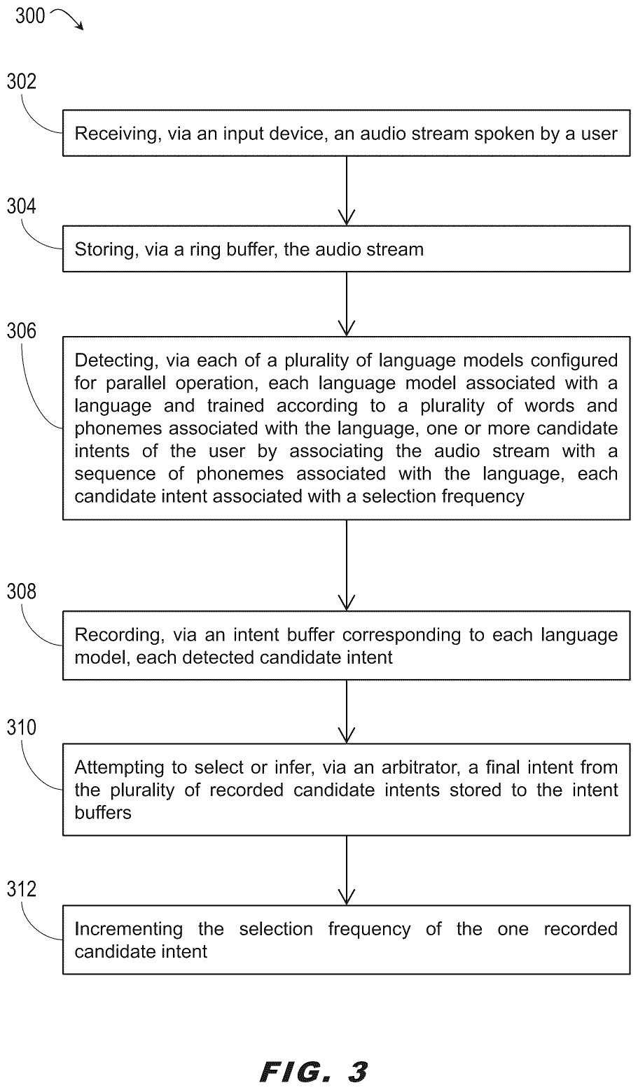

Referring now to FIG. 3, the method 300 may be implemented by the speech recognition system 100 and may include the following steps.

At a step 302, an input device receives one or more voice commands or spoken directions from a user, which are processed by codecs into a digital audio stream. For example, the audio stream may correspond to a sequence of phonemes applicable to one or more languages.

At a step 304, a ring buffer stores the audio stream.

At a step 306, two or more language models concurrently analyze the audio stream in parallel. For example, each language model is trained on a library of words, phonemes, and/or pronunciations and to recognize voice commands in a particular language (the trained library exceeding the scope of specific voice commands). The language models receive the audio stream and simultaneously (e.g., in real time or near real time) attempt to determine a candidate intent of the audio stream by analyzing the audio stream, e.g., against its library of words and phonemes, and attempting to correlate the audio stream to a sequence of words or phonemes from its modelled language. In embodiments, if the audio stream sufficiently matches (e.g., to a sufficient confidence level) a correlated sequence of phonemes or words corresponding to a particular voice command or commands in the modelled language, the language model detects a candidate intent of the audio stream. For example, within a given set of language models, one or more language models may not correlate the audio stream with a sequence of words or phonemes, or with a voice command, with sufficient confidence to detect a candidate intent. In embodiments, each language model may be associated with a set of potential intents (e.g., words, phrases, commands, instructions, or sets thereof), each potential intent having a selection frequency indicative of how often (e.g., throughout the operating lifetime of the speech recognition system, which may include pre-training and/or predetermined initial selection frequency levels) the potential intent has been selected by the arbitrator as a final intent of an audio stream. In some embodiments, the selection frequency of a potential intent may additionally reflect how often the potential intent has been correctly selected as a final intent (e.g., as determined by the arbitrator based on alternative control input subsequently correlated to final-intent selections or inferences made by th arbitrator).

At a step 308, one or more of the language models records the detected candidate intent in an intent buffer (if, for example, a particular language model successfully detected a candidate intent, that candidate intent will be recorded to the intent buffer). In some embodiments, additional data with respect to a candidate intent (e.g., a confidence level of the candidate intent) may be recorded with the candidate intent.

At a step 310, an arbitrator attempts to select or infer a final intent of the audio stream from the set of recorded candidate intents detected by the set of language models. For example, if only one candidate intent is present, that single candidate intent is selected as the final intent. Alternatively, if a candidate intent (e.g., of a pool of two or more recorded candidate intents) matches the language of the most recently selected final intent (e.g., the default language), that candidate intent is selected as the final intent. Alternatively, if multiple candidate intents are present, each candidate intent corresponding to a different command or instruction (or set thereof), the arbitrator infers as the final intent the candidate intent having the highest confidence level (e.g., if confidence levels are provided). In some embodiments, if confidence levels are not available or dispositive, the arbitrator infers a final intent based on the candidate intent having the highest selection frequency. For example, confidence levels may not be available. Alternatively, two or more candidate intents may share a highest confidence level; these candidate intents may correspond to the same voice command/s, but this would preclude the arbitrator from selecting a correct language. In some embodiments, when the arbitrator selects a final intent based on detection of a single candidate intent, the arbitrator may also set the language associated with the selected final intent as a default language (e.g., for use with any subsequent audio streams and/or the selection of subsequent candidate intents derived therefrom).

In some embodiments, the method 300 may include an additional step 312. At the step 312, when the arbitrator selects a final intent based on detection of a single candidate intent, the arbitrator increments the selection frequency for the single candidate intent selected as the final intent. In some embodiments, the arbitrator respectively increments or decrements the selection frequency of a selected final intent when the said final intent is respectively determined to be a correct selection (e.g., accurately interpreting the user's intent) or an incorrect selection (e.g., erroneously interpreting the user's intent).

### CONCLUSION

It is to be understood that embodiments of the methods disclosed herein may include one or more of the steps described herein. Further, such steps may be carried out in any desired order and two or more of the steps may be carried out simultaneously with one another. Two or more of the steps disclosed herein may be combined in a single step, and in some embodiments, one or more of the steps may be carried out as two or more sub-steps. Further, other steps or sub-steps may be carried in addition to, or as substitutes to one or more of the steps disclosed herein.

Although inventive concepts have been described with reference to the embodiments illustrated in the attached drawing figures, equivalents may be employed and substitutions made herein without departing from the scope of the claims. Components illustrated and described herein are merely examples of a system/device and components that may be used to implement embodiments of the inventive concepts and may be replaced with other devices and components without departing from the scope of the claims. Furthermore, any dimensions, degrees, and/or numerical ranges provided herein are to be understood as non-limiting examples unless otherwise specified in the claims.

1. A multilingual speech recognition system, comprising:
a ring buffer configured to store at least one audio stream spoken by a user;
a memory configured for storage of encoded instructions executable by at least one processor;
and
the at least one processor configurable by the encoded instructions to execute:
a plurality of language models connected in parallel to the ring buffer, wherein each language model is associated with a language and trained according to a plurality of words and phonemes associated with the language, and wherein each language model is configured to:
receive the audio stream from the ring buffer;
detect a candidate intent of the spoken audio stream by associating the audio stream with a sequence of phonemes corresponding to the trained language, wherein each candidate intent is associated with a selection frequency;
and
record the candidate intent in an intent buffer;
and
an arbitrator configured to:
attempt a selection of a final intent from the one or more recorded candidate intents.

2. The multilingual speech recognition system of claim 1, wherein the one or more recorded candidate intents consist of a single candidate intent, and wherein the arbitrator is configured to select as the final intent the single candidate intent.

3. The multilingual speech recognition system of claim 2, wherein:
the arbitrator is configured to increment the selection frequency associated with the single candidate intent selected as the final intent.

4. The multilingual speech recognition system of claim 2, wherein the arbitrator is configured to set as a default language the language associated with the single candidate intent.

5. The multilingual speech recognition system of claim 4, wherein the audio stream is a first audio stream, the one or more candidate intents are first candidate intents, and the final intent is a first final intent, wherein:
the ring buffer is configured to store a subsequent audio stream;
wherein the plurality of language models are configured to detect and record one or more second candidate intents of the subsequent audio stream;
and
wherein the arbitrator is configured, when the one or more second candidate intents include a matching candidate intent corresponding to the default language, to select the matching candidate intent as a subsequent final intent corresponding to the subsequent audio stream.

6. The multilingual speech recognition system of claim 1, wherein each language model is configured to:
determine a confidence level associated with each detected candidate intent;
and
record the confidence level in the intent buffer.

7. The multilingual speech recognition system of claim 6, wherein the arbitrator is configured to infer as the final intent the recorded candidate intent having a highest confidence level of the one or more recorded candidate intents.

8. The multilingual speech recognition system of claim 7, wherein the arbitrator is configured to store to the memory one or more of:
the inferred final intent;
the sequence of phonemes associated with the inferred final intent;
or
the confidence level associated with the inferred final intent.

9. The multilingual speech recognition system of claim 6, wherein:
the one or more recorded candidate intents includes two or more first recorded candidate intents sharing a highest confidence level;
and
wherein the arbitrator is configured to infer as the final intent the first recorded candidate intent having a highest selection frequency of the one or more recorded candidate intents.

10. The multilingual speech recognition system of claim 9, wherein the arbitrator is configured to store to the memory a similarity metric corresponding to the two or more first recorded candidate intents, the similarity metric based on one or more of:
a similarity of at least one voice command associated with each first recorded candidate intent;
a similarity of the sequence of phonemes associated with each first recorded candidate intent;
or
a similarity of the language associated with each first recorded candidate intent.

11. The multilingual speech recognition system of claim 1, wherein:
each recorded candidate intent corresponds to at least one voice command executable by a controlled system operatively coupled to the speech recognition system;
and
wherein the arbitrator is configured to forward to the controlled system at least one voice command corresponding to the selected final intent.

12. The multilingual speech recognition system of claim 1, further comprising:
an input device coupled to the ring buffer, the input device configured for receiving the spoken audio stream from the user.

13. The multilingual speech recognition system of claim 1, wherein:
the arbitrator fails to select or infer a final intent from the one or more recorded candidate intents.

14. The multilingual speech recognition system of claim 13, further comprising:
an alert system operatively coupled to the at least one processor, the alert system configured for, when the arbitrator fails to select or infer the final intent, at least one of:
alerting the user to the failure to select;
and
prompting the user to repeat the audio stream.

15. A computer-assisted method for multilingual speech recognition, the method comprising:
receiving, via an input device, an audio stream spoken by a user;
storing, via a ring buffer, the audio stream;
detecting, via each of a plurality of language models configured for parallel operation, each language model associated with a language and trained according to a plurality of words and phonemes associated with the language, one or more candidate intents of the user by associating the audio stream with a sequence of phonemes associated with the language, each candidate intent associated with a selection frequency;
recording, via an intent buffer corresponding to each language model, each detected candidate intent;
and
attempting to select or infer, via an arbitrator, a final intent from the one or more recorded candidate intents stored to the intent buffers.

16. The computer-assisted method of claim 15, wherein:
the one or more recorded candidate intents consist of a single candidate intent;
and
wherein attempting to select or infer, via an arbitrator, a final intent from the one or more recorded candidate intents stored to the intent buffers includes:
selecting as the final intent, via the arbitrator, the single candidate intent;
and
setting as a default language the language associated with the single candidate intent.

17. The computer-assisted method of claim 16, further comprising:
incrementing the selection frequency of the single candidate intent selected as the final intent.

18. The computer-assisted method of claim 16, wherein the one or more candidate intents include a matching candidate intent, the language associated with the matching candidate intent corresponding to the default language;
and
wherein attempting to select or infer, via an arbitrator, a final intent from the one or more recorded candidate intents stored to the intent buffers includes:
selecting as the final intent, via the arbitrator, the matching candidate intent.

19. The computer-assisted method of claim 15, wherein:
detecting, via each of a plurality of language models configured for parallel operation, at least one candidate intent of the user includes:
determining, via each language model, a confidence level of the candidate intent;
and
recording, via each language model, the confidence level to the intent buffer with its associated candidate intent;
and
wherein attempting to select or infer, via an arbitrator, a final intent from the one or more recorded candidate intents stored to the intent buffers includes:
inferring as the final intent, via the arbitrator, the recorded candidate intent having a highest confidence level of the one or more recorded candidate intents.

20. The computer-assisted method of claim 19, wherein:
the one or more recorded intents include two or more first recorded candidate intents sharing a highest confidence level;
and
wherein attempting to select or infer, via an arbitrator, a final intent from the one or more recorded candidate intents stored to the intent buffers includes:
inferring as the final intent, via the arbitrator, the first recorded candidate intent having a highest selection frequency of the one or more recorded candidate intents.
